(19) United States
(12) Patent Application Publication
(10) Pub. No.: US 2011/0293932 A1
(43) Pub. Date: Dec. 1, 2011

(54) ADHESION WITH NANOCRYSTALLINE CELLULOSE

(75) Inventors: Zhi-Hua JIANG, Kirkland (CA); Richard BERRY, Notre-Dame-de-I'Ile-Perrot (CA); Jean BOUCHARD, Montreal (CA); André AUDET, Salaberry de Valleyfield (CA)

(73) Assignee: FPINNOVATIONS, Pointe-Claire (CA)

(21) Appl. No.: 13/116,294

(22) Filed: May 26, 2011

Related U.S. Application Data
(60) Provisional application No. 61/349,032, filed on May 27, 2010.

(51) Int. Cl. B32B 27/00; B32B 23/04; C09J 101/06

(52) U.S. Cl. 428/340; 156/336; 428/532

(57) ABSTRACT

Nanocrystalline cellulose (NCC) obtained by sulfuric acid hydrolysis is used as an adhesive. Aqueous suspensions of NCC in acid form H-NCC or in a neutralized form in which protons of the acid form are replaced by a monovalent cation such as sodium ion are adhesives.

### CROSS-REFERENCE TO RELATED APPLICATION

This application claims the benefit under 35 USC 119(e) of U.S. Provisional Application 61/349,032, filed May 27, 2010.

### BACKGROUND OF THE INVENTION

1. Field of the Invention

The present invention relates to the use of nanocrystalline cellulose (NCC) obtained by sulfuric acid hydrolysis as an adhesive. The invention provides a method of bonding and bonded structures based on the adhesive.

2. Description of the Prior Art

Cellulose, a linear macromolecule composed of (1→4)-β-D-gluco-pyranose, is the most abundant organic material on earth. It is contained in virtually all plants and is also known to be present in bacteria, fungi, algae and in fauna. Cellulose has crystalline and amorphous regions. Acids preferentially hydrolyze the amorphous regions of cellulose yielding dispersions of cellulose nanocrystals.

Nanocrystalline cellulose (NCC) is rod shaped with an aspect ratio which varies from 10 to 100 nm depending on the cellulose source. Wood cellulose nanocrystals average 180-200 nm in length with a cross section of 3-5 nm. Nanocrystal dimensions also depend to a certain extent on the hydrolysis conditions used to obtain them.

NCC suspensions produced by sulfuric acid hydrolysis (H-NCC) are not dispersible in water or other aqueous solvent once they have been fully dried. When the proton counterion is exchanged for monovalent cationic counterions, then the dried solid NCC is readily dispersible in water.

NCC has been widely recognized as a material with strong reinforcing capabilities and the ability to form composites with various matrixes.

### SUMMARY OF THE INVENTION

It is an object of this invention to provide a novel adhesive comprising a suspension of nanocrystalline cellulose (NCC).

It is another object of the invention to provide a method of bonding with an adhesive comprising a suspension of nanocrystalline cellulose (NCC).

It is a further object of the invention to provide a bonded structure in which the bond is derived from an adhesive comprising a suspension of nanocrystalline cellulose (NCC).

According to one aspect, the present invention relates to the use of the nanocrystalline cellulose (NCC) suspension obtained directly from acid hydrolysis as an adhesive.

According to another aspect, the present invention relates to the use of dispersible dried NCC, as an adhesive when dispersed in other liquid media.

In still another aspect of the invention, there is provided a method of bonding comprising: applying a nanocrystalline cellulose (NCC) suspension between first and second surfaces, bringing said surfaces into contact with said suspension therebetween, and drying the suspension.

In yet another aspect of the invention, there is provided use of a suspension of nanocrystalline cellulose (NCC) as an adhesive.

In still a further aspect of the invention, there is provided a bonded structure comprising first and second components bonded at adjacent opposed surfaces by a dried coating of a suspension of nanocrystalline cellulose (NCC.

The term “adhesive” refers here to a compound in a liquid or semi-liquid stage that bonds items together.

### DETAILED DESCRIPTION OF THE INVENTION

NCC in suspension was applied to the surfaces of several different materials, the surfaces were placed against one another and the NCC suspension between the surfaces was allowed to dry. Surprisingly, it was found that these materials were strongly bonded.

The suspensions of the invention are in particular aqueous suspensions which could also be mixed with known common solvents such as a class of alcohol, ether, ester, acetate, aldehyde, ketone, benzene and organic acid.

In particular embodiments, the suspensions have a content of NCC up to 60%, especially 10-30%, by weight, based on the weight of the suspension. The NCC suspension is suitably applied as a coating to a substrate to be bonded at a dry coating weight up to 30%, especially 1-10% by weight of NCC/dry weight of the substrate. Stated in terms of coating weight of NCC per unit area of one of the two substrates being bonded together, the charge of NCC would be up to 50 mg/cm², especially 0.5 to 5 mg/cm², of NCC/area of the substrate being coated for bonding.

The NCC suspension may be one produced by sulfuric acid hydrolysis of cellulose to produce (H-NCC) in suspension. The suspension may also be D-NCC being one formed by exchanging the proton counterion of H-NCC with monovalent cationic counterions, for example alkali metal cations such as sodium, potassium and rubidium ions, forming a dried film from the resulting suspension and re-dispersing the dried film in water or in water mixed with known common solvents.

### BRIEF DESCRIPTION OF DRAWING

FIG. 1 is a photograph demonstrating bonding of a paper sheet to a metal surface with an adhesive of the invention.

### EXAMPLES

The invention will be illustrated in more detail by the specific examples which follow. NCC used in these samples is either H-NCC obtained by sulfuric acid hydrolysis of wood pulp [2] or dispersible dried NCC redispersed in a liquid media in U.S. patent application Ser. No. 12/654,084 which is designated as D-NCC, the teachings of which are incorporated herein by reference.

### Example 1

Two paper sheets of commercial business paper from Xerox (Xerox Business 4200 Paper) were used in this example. The surface of one of the sheets was coated on one side with D-NCC water suspension with a solid content of D-NCC of 10% dry weight, based on the weight of the sheet which is coated. After coating, the NCC coated surface was placed against the uncoated surface of the other paper sheet. No pressure was applied except that a rule was used to smooth the paper surfaces when one sheet was placed against the other. The two-sheet structure was maintained at a room temperature for a time of 24 hours. At the end of the time, the paper structure was moved to the humidity control room and allowed to equilibrate before testing.

To test the bonding strength, test samples, each having an area of 6.45 cm² areas were cut from the paper structure and assessed with the PAPTAC standard method D.37P which is used to measure Z-directional strength of paper and paperboard. Each side of the two-sheet samples was mounted with a layer of double-coated pressure-sensitive tape between two aligned and removable platens to achieve a bond between the sample surface and the platens. A test cycle consisted of a compression stroke, a dwell time and a tension stroke which causes the splitting of the test specimen. As a comparison, a one-sheet paper sample without coating with NCC was also subjected to the same test.

The results of the test are shown in the following table. Six one-sheet samples for the control and 4 two-sheet bonded samples were measured and averaged.

Z-directional strength (kPa)

| Paper | | Standard | | |
|---|---|---|---|---|
| Sample | Average | deviation | Minimum | Maximum |
| One- | 691.8 | 37.0 | 639.9 | 734.7 |
| sheet | | | | |
| control | | | | |
| Two- | 609.5 | 93.0 | 537.4 | 742.1 |
| sheet | | | | |
| bonded | | | | |
| sample | | | | |

It was found that there was no failure of the two-sheet structure along the adhesion line during the test and instead the paper in the two-sheet structure was delaminated, demonstrating that the adhesive bond strength between the two paper samples was higher that the internal fiber bond strength of the paper sample itself.

A further test of the bonding strength was done using PAPTAC standard method D.34 which is used to measure tensile breaking properties of paper and paperboard.

Two paper sheets of commercial business paper from Xerox (Xerox Business 4200 Paper) were used in this example. A portion of the surface of one of the sheets with an area of 2.5 cm×2.5 cm was coated on one side with D-NCC water suspension with a solid content of D-NCC of 10% dry weight, based on the weight of the sheet which is coated. After coating, the NCC partially coated paper sheet was placed against the other paper sheet. No pressure was applied except that a rule was used to smooth the paper surfaces when one sheet was placed against the other. The partially bonded two-sheet structure was maintained at a room temperature for a time of 24 hours. At the end of the time, the paper structure was moved to the humidity control room and allowed to equilibrate before testing.

To test the bonding strength, test samples 1.5 cm wide and 12.5 cm long, each containing the bonded area in the center, were cut from the paper structure. Each test specimen therefore contains 2.5 cm long bonded area and 5 cm long single sheet in each side. The both sides of the single sheet area of the test specimen were clamped in instrument jaws with the bonded area in the center and the test specimen was stretched to the point where rupture occurs. As a comparison, a one-sheet paper sample without coating with NCC was also subjected to the same test. Ten one-sheet samples for the control and ten two-sheet bonded samples were measured and averaged.

The results of the test are as follows:

| | Load at break (N) | | | |
|---|---|---|---|---|
| | | Standard | | |
| Paper Sample | Average | deviation | Minimum | Maximum |
| One-sheet control | 32.83 | 0.84 | 31.85. | 33.87 |
| Two-sheet bonded | 32.38 | 2.41 | 28.16 | 35.42 |
| sample | | | | |

Again, it was the paper sheet that failed and not the bond between the paper surfaces which demonstrates again that the adhesive bond strength between the two paper samples is higher that the internal fiber bond strength of the paper sample itself.

### Example 2

Two 3 ply oak veneer plywood boards with each ply having a thickness of 0.27 cm were used in this example. The surface of one of the boards was coated on one side with D-NCC water suspension or with H-NCC with a solid content of NCC of 10% dry weight, based on the weight of the board which is coated. After coating, the NCC coated surface was placed against the uncoated surface of the other plywood board. The two-board structure was clamped together with a hand clamp and put in the oven for 18 hr at 55° C. At the end of the time, the wood structure was moved to a humidity control room and allowed to equilibrate before testing.

To test the bonding strength, four two-board samples, each having a bonding area of 6.45 cm² areas, were tested and assessed with the PAPTAC standard method D.37P as described above. As a comparison, four single plywood board samples not coated with NCC were also subjected to the same test.

The results of the test are shown in the following table four single plywood board samples for the control and four two-board bonded samples were measured and averaged:

| | Z-directional strength (kPa) | | | |
|---|---|---|---|---|
| | | Standard | | |
| Plywood Sample | Average | deviation | Minimum | Maximum |
| Plywood control | 648.0 | 55.5 | 601.8 | 717.1 |
| Two-board bonded | 668.9 | 47.6 | 587.4 | 707.2 |
| sample with D-NCC | | | | |
| Two-board bonded | 667.8 | 65.2 | 595.6 | 722.3 |
| sample with ND-NCC | | | | |

It was found that there was no failure of the two-plywood board bonded structure along the adhesion line during the test. Instead the double layer tape failed, demonstrating that the adhesive bond strength between the two wood samples was higher that the tape strength.

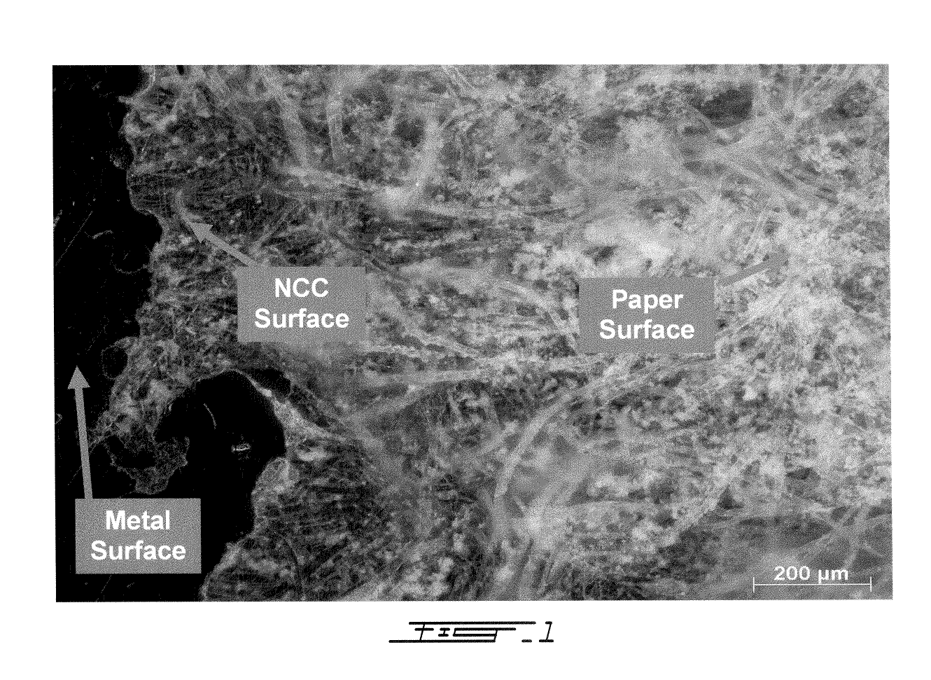

The adhesive of the invention may be employed in bonding cellulosic based materials such as paper and wood, but also other materials such as metals such as steel, glass and plastic, FIG. 1 illustrates that a paper sheet can be glued to a metal surface with NCC and shows the sample's surfaces observed under a light microscope (LM).

### REFERENCES

1. Beck, S., Bouchard. J., and Berry, R., “Controlling the dispersibility and barrier properties of dried nanocrystalline cellulose in aqueous electrolyte solutions”, U.S. patent application Ser. No. 12/654,084, filed Dec. 10, 2009.
2. Revol, J-F., Godbout, L., and Gray, D. G., “Solid self-assembled films of cellulose with chrial nematic order and optically variable properties”, J. Pulp Pap. Sci., 24(5):146-149, 1998.

1. A method of bonding comprising: applying a nanocrystalline cellulose (NCC) suspension between first and second surfaces, bringing said surfaces into contact with said suspension therebetween, and drying said suspension.

2. The method of claim 1, wherein said suspension is applied as a coating to at least one of said surfaces.

3. The method of claim 1, wherein said suspension is an aqueous suspension.

4. The method of claim 2, wherein said suspension is an aqueous suspension.

5. The method of claim 1, wherein said suspension is of H-NCC, acid form of nanocrystalline cellulose.

6. The method of claim 2, wherein said suspension is of H-NCC, acid form of nanocrystalline cellulose.

7. The method of claim 3, wherein said suspension is of H-NCC, acid form of nanocrystalline cellulose.

8. The method of claim 1, wherein said suspension is of D-NCC, in which D is a monovalent cation which has replaced protons of the acid form of nanocrystalline cellulose.

9. The method of claim 2, wherein said suspension is of D-NCC, in which D is a monovalent cation which has replaced protons of the acid form of nanocrystalline cellulose.

10. The method of claim 3, wherein said suspension is of D-NCC, in which D is a monovalent cation which has replaced protons of the acid form of nanocrystalline cellulose.

11. The method of claim 1, wherein said suspension is applied as a coating to a surface of a substrate to be bonded in a dry coating weight of 1 to 10% by weight of NCC/weight of the substrate.

12. The method of claim 1, wherein said suspension is applied as a coating to a surface of a substrate to be bonded in a dry coating weight of 0.5 to 5 mg/cm², of NCC/area of the substrate.

13. A bonded structure comprising first and second components bonded at adjacent opposed surfaces by a dried coating of a suspension of nanocrystalline cellulose (NCC.

14. The bonded structure of claim 13, wherein said suspension is an aqueous suspension.

15. The bonded structure of claim 13, wherein said dried coating is of H-NCC, acid form of nanocrystalline cellulose.

16. The bonded structure of claim 14, wherein said suspension is of H-NCC, acid form of nanocrystalline cellulose.

17. The bonded structure of claim 13, wherein said dried coating is of D-NCC, in which D is a monovalent cation which has replaced protons of the acid form of nanocrystalline cellulose.

18. The bonded structure of claim 13, wherein said coating is in a dry coating weight of 0.5 to 5 mg/cm², of NCC/bonding area of the substrates.

19. The bonded structure of claim 16, wherein said coating is in a dry coating weight of 0.5 to 5 mg/cm², of NCC/bonding area of the substrates.

20. The bonded structure of claim 17, wherein said coating is in a dry coating weight of 0.5 to 5 mg/cm², of NCC/bonding area of the substrates.
